(19) United States
(12) Patent Application Publication
(10) Pub. No.: US 2026/0191364 A1
(43) Pub. Date: Jul. 9, 2026

(54) SYSTEM AND METHOD FOR DISPENSING A FOOD PRODUCT

(71) Applicant: Server Products, Inc., Richfield, WI (US)

(72) Inventors: Jordan W. Nielsen, Mayville, WI (US); Kyle Perrin, Richfield, WI (US)

(21) Appl. No.: 19/135,339

(22) PCT Filed: Dec. 12, 2023
(86) PCT No.: PCT/US2023/083702

§ 371 Date: Jun. 3, 2025

Related U.S. Application Data
(60) Provisional application No. 63/431,799, filed on Dec. 12, 2022.
(60) Provisional application No. 63/498,002, filed on Apr. 24, 2023.

(51) Int. Cl. A47J 47/01; A47F 10/06

(52) U.S. Cl. CPC A47J 47/01; A47F 10/06

(57) ABSTRACT

A dispensing system for a flowable food product includes a base unit and a reservoir configured to hold the flowable food product to be dispensed by the base unit. The base unit defines an opening that includes a base unit connector. The reservoir is configured to be inserted into the opening and includes a reservoir connector configured to couple to the base unit connector and a valve configured to open and close to control a flow of flowable food product from the reservoir. Inserting the reservoir into the opening cause the valve to open and removing the reservoir from the opening causes the valve to close.

### CROSS-REFERENCE TO RELATED APPLICATIONS

The present application is based on and claims the benefit of U.S. Provisional Patent Application Ser. No. 63/498,002, filed Apr. 24, 2023, and U.S. Provisional Patent Application Ser. No. 63/431,799, filed Dec. 12, 2022, each of which is incorporated herein by reference in its entirety.

### BACKGROUND

The present disclosure relates to dispensing systems for dispensing a flowable food product. More specifically, the present disclosure relates to systems and methods for coupling a pump system to a reservoir (e.g., a bag or container) that is configured to hold a flowable food product to be dispensed.

### SUMMARY

A dispensing system according to the present disclosure can include a reservoir that can be coupled to a pump of a base unit to dispense a flowable food product. The reservoir can include a valve configured to open and close to allow the food product to flow from the reservoir to the pump. The base unit can be configured to engage with the valve so that connecting the reservoir to the base unit opens the valve when the reservoir is coupled to the pump system and disconnecting the reservoir from the base unit closes the valve when the reservoir is coupled to the pump system. In this way, the dispensing system can minimize spills and drips as a result of connecting and disconnecting the reservoir from the base unit (e.g., for refilling the reservoir or for cleaning). Correspondingly, the system can allow for clean-in-place applications that allow the dispensing system to be cleaned without needing to remove internal components (e.g., a pump, tubing, etc.) from the base unit.

According to one aspect of the disclosure, a dispensing system for a flowable food product may include a base unit configured to dispense the flowable food product. The base unit may include an opening that includes a base unit connector. The dispensing system may further include a reservoir configured to be inserted into the opening and to hold the flowable food product to be dispensed by the base unit. The reservoir may include a reservoir connector configured to couple to the base unit connector and a valve. The valve may be configured to open and close to control a flow of flowable food product from the reservoir. Inserting the reservoir into the opening can cause the valve to open and removing the reservoir from the opening can cause the valve to close.

In some non-limiting examples, the valve of the dispensing system can be configured to open when the reservoir connector is coupled with the base unit connector.

In some non-limiting examples, the valve of the dispensing system can further include a lever that can be configured to engage with the base unit. The lever may be configured to move between a first lever position that can close the valve and a second lever position that can open the valve.

In some non-limiting examples, the base unit can include a slot formed within the opening. The slot can be configured to receive the lever and to move the lever between the first lever position and the second lever position.

In some non-limiting examples, the slot can have a J-shape with a straight portion that can be configured to place the lever in the first lever position and a curved region that can be configured to place the lever in the second lever position.

In some non-limiting examples, the slot can include the curved region that may be positioned closer to the base unit connector than is the straight region. Therefore, inserting the reservoir into the opening can move the lever from the first lever position to the second lever position and removing the reservoir from the opening can move the lever from the second lever position to the first lever position.

In some non-limiting examples, when inserted into the opening the reservoir can cause the lever to engage with a first side of the slot to rotate the lever from the first lever position to the second lever position and removing the reservoir from the opening can cause the lever to engage with a second side of the slot to rotate the lever from the second lever position to the first lever position.

In some non-limiting examples, the reservoir can be configured move relative to the base unit between each of a first reservoir position in which the reservoir connector may be decoupled from the base unit connector and the valve may be closed, a second reservoir position in which the reservoir connector may be coupled to the base unit connector and the valve may be closed, and a third reservoir position in which the reservoir connector may be coupled to the base unit connector and the valve may be open.

In some non-limiting examples, the base unit can further include a pump system that may be retained within a housing of the base unit and an electronic controller that may be configured to operate the pump system to dispense the flowable food product from the reservoir.

In some non-limiting examples, the electronic controller can be configured to dispense the flowable food product based on an input signal provided by at least one of a user interface and a kitchen management system.

In some non-limiting examples, the dispenser and the reservoir can collectively form one of a plurality dispensers that can be arranged in at least one of a stacked configuration and a side-by-side configuration.

According to one aspect of the disclosure, a method of using a dispensing system can include inserting a reservoir into an opening defined in a base unit to couple the reservoir to a pump system of the base unit and to cause a valve to move from a closed configuration to an open configuration to allow a flowable food product to flow from the reservoir to the pump system. The method may further include removing the reservoir from the opening to decouple the reservoir from the pump system and to cause the valve to move from the open configuration to the closed configuration to block the flow of the flowable food product from the reservoir to the pump system.

In some non-limiting examples, the method may further include wherein the valve can be coupled to the reservoir and can include a lever that is configured to move with a slot defined by the base unit.

In some non-limiting examples, the method can further include wherein inserting the reservoir into an opening can move the lever from a first region of the slot to a second region of the slot to open the valve and removing the reservoir from the opening can move the lever from the second region to the first region to close the valve.

In some non-limiting examples, the method can further include wherein the second region may be positioned so that the reservoir may be coupled to the pump system when the valve transitions between the open configuration and the closed configuration.

According to one aspect of the disclosure, a dispenser for a dispensing system can include a dispensing unit defining an opening. The dispenser may further include a reservoir that may be configured to sealingly couple to the dispensing unit. The reservoir may include a valve configured to control a flow of a flowable food product from the reservoir to the dispensing unit. The reservoir may be moveable within the opening between each of a first reservoir position in which the reservoir may be decoupled from the dispensing unit and the valve may be closed, a second reservoir position in which the reservoir may be coupled to the base unit connector and the valve may be closed, and a third reservoir position in which the reservoir may be coupled to the base unit connector and the valve may be open.

In some non-limiting examples, the dispensing unit may further include a slot that may be configured to receive and rotate a lever to open and close the valve.

In some non-limiting examples, the slot may define a first region that may correspond to a fully closed configuration of the valve and a second region that may correspond to a fully open configuration of the valve.

In some non-limiting examples, the lever may be in the first region when the reservoir is in the first reservoir position, the lever may be in the second region when the reservoir is in the third reservoir position, and the lever may be in both the first region and the second region when the reservoir is in the second reservoir position.

In some non-limiting examples, the lever may be in a first rotational position when the reservoir is in the first reservoir position, may be in a second rotational position when the reservoir is in the third reservoir position, and may be in a third lever position when the reservoir is in the second reservoir position. The third rotational position may correspond to a cracking position of the valve.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is an isometric view of a dispensing system, according to aspects of the disclosure.

FIG. 2 is an isometric view of a dispenser of the dispensing system of FIG. 1, according to aspects of the disclosure.

FIG. 3 is a front view of the dispenser of FIG. 2.

FIG. 4 is a rear view of the dispenser of FIG. 2.

FIG. 5 is a left side view of the dispenser of FIG. 2.

FIG. 6 is a right side view of the dispenser of FIG. 2.

FIG. 7 is a top view of the dispenser of FIG. 2.

FIG. 8 is a bottom view of the dispenser of FIG. 2.

FIG. 9 is an exploded view of the dispenser of FIG. 2.

FIG. 10 is a partial section view of the dispenser of FIG. 2.

FIG. 11 a partial schematic view of the dispenser of FIG. 2 with a reservoir inserted into a base unit in a first position.

FIG. 12 a partial schematic view of the dispenser of FIG. 2 with the reservoir inserted into the base unit in a second position.

FIG. 13 a partial schematic view of the dispenser of FIG. 2 with the reservoir inserted into the base unit in a third position.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, and may also include fluid and electrical connections. Throughout the disclosure, the terms “about” and “approximately” refer to a range of values+5% of the numeric value that the term precedes

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Dispensing systems can be used to dispense flowable food products (e.g., sauces, dressings, condiments, etc.). Flowable food products can include a wide variety of products, such as condiments (e.g., ketchup, mustard, mayonnaise, tartar sauce, etc.) syrups, dressings, cheeses, fudge, caramel, sauces, wing sauces or other similar food products that can flow and thus be pumped. Flowable food products can include a wide variety of viscosities, non-Newtonian properties, can include small particulates and can be dispensed in a wide range of temperatures from cold to hot. Flowable food products can also be heated food products such as liquid cheese, hot ice cream toppings or chilled food products.

For example, a dispensing system can include one or more dispensers that can dispense a type or quantity of a flowable food product based on an input signal from a worker or kitchen management system (e.g., a system configured to manage and operate various kitchen operations, including ordering, food preparation, inventory, etc.). Correspondingly, an input signal can be provided to the dispensing system to dispense a desired amount of one or more flowable food products. The input signal may vary depending on the particular application, but in general, can be a manual input (e.g., from a worker) or electronic signal (e.g., from a management system) that can include a quantity or type of flowable food product. In other cases, the input signal can include information on a type or quantity of food product (e.g., chicken wings, cauliflower, or other type of food product) and the dispensing system may dispense a quantity or type of flowable food product based on the food product to which the flowable food product is being added. Accordingly, the dispensing system can be used as a manual dispensing system, in which the type or quantity of flowable food product is determined by a worker, or as an automatic dispensing system that is configured to determine the type or quantity of flowable food product being dispensed (e.g., via an electronic controller configured to receive an input signal and determine an amount or type of flowable food product to dispense based on the input signal). The dispenser can dispense a known and repeatable volume of flowable food product based upon a selection made by the user, or other input signal received by the system.

In general, a dispenser for a dispensing system can include a base unit configured to dispense a flowable food product that can accurately control the operation of a pump to dispense the desired amount and volume of the flowable food product. The base unit can include an interface (i.e., a user or communication interface) configured to receive an input signal from a user or kitchen management system. Based on the input signal, the base unit can operate a pump therein to dispense the desired amount or type of flowable food product. In some cases, a quantity of flowable food product can stored in a reservoir, which can be selectively coupled with the pump. The reservoir can be a container configured to store the flowable food product for dispensing. Correspondingly, the reservoir can be configured to allow flowable food product to be poured directly therein, or the reservoir can be configured to hold a separate container (e.g., a ridged container or flexible bag) that contains the flowable food product. In either case, as the flowable food product is dispensed, the reservoir will gradually become depleted, requiring that the reservoir be refilled from time to time.

In some non-limiting examples, the reservoir can be configured as a removeable reservoir that can be selectively connected and disconnected from the base unit to allow for refilling, as well as for cleaning the base unit (e.g., the pump and any internal tubing, allowing for clean-in-place applications). When connecting and disconnecting the reservoir from the base unit (e.g., a pump thereof), it is possible that flowable food product can drip from the reservoir or pump connection.

According to aspects of the disclosure, a reservoir and base unit can be configured to reduce dripping when connecting and disconnecting the reservoir with the base unit. For example, a reservoir can include a valve (e.g., a shut-off valve) configured to engage with the base unit (e.g., via a base unit connector) so that the valve opens and closes as the reservoir is connected and disconnected from the base unit. In this way, the valve can open and close to control (e.g., allow or block) a flow of flowable food product from the reservoir. In one particular example, the valve can include a lever that can be received in a slot of the base unit. As the reservoir is moved relative to the base unit, the lever can move within the slot. Correspondingly, the slot can be shaped to cause the lever to rotate to open and close the valve. Thus, as the reservoir is connected to the base unit, the interaction of the lever with the slot causes the valve to open and allow flowable food product to be pumped from the reservoir by the pump. Conversely, as the reservoir is disconnected from the base unit, the interaction of the lever with the slot causes the valve to close to minimize dripping. Moreover, in some cases, a connector of the reservoir (e.g., a first connector) can be configured to sealingly connect with a corresponding connector of the base unit (e.g., a second connector), and the slot can be configured to open the and close the valve when the reservoir connector is sealingly coupled with the base unit connector to further minimize dripping.

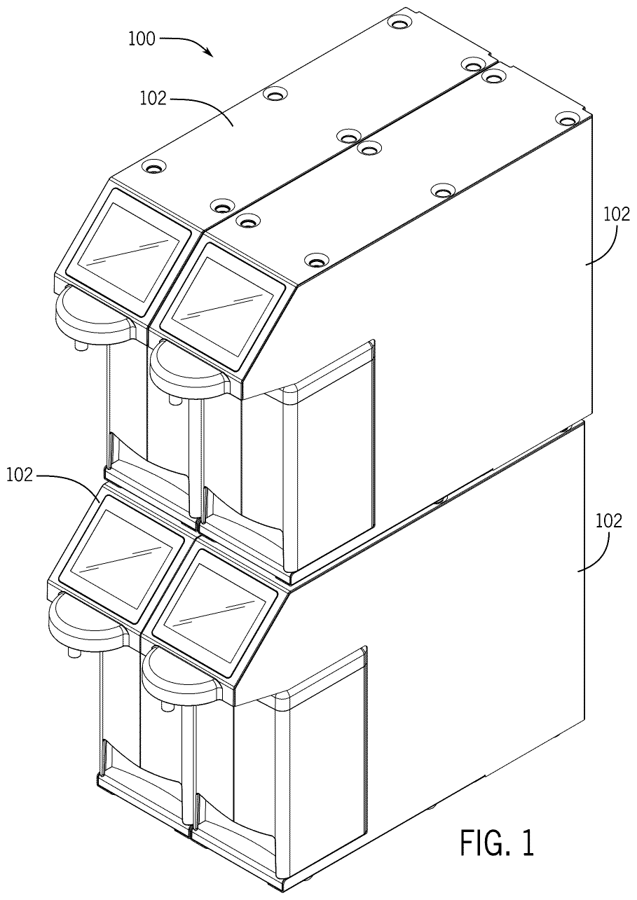

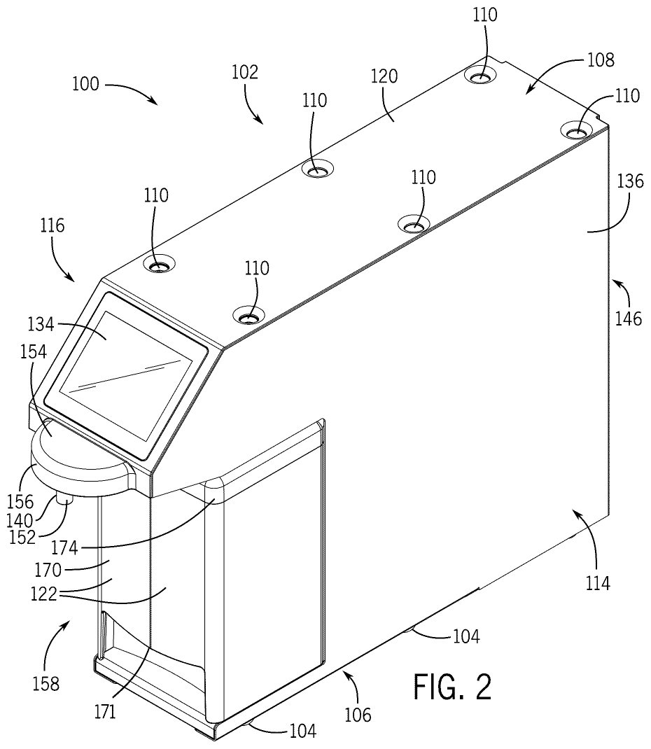

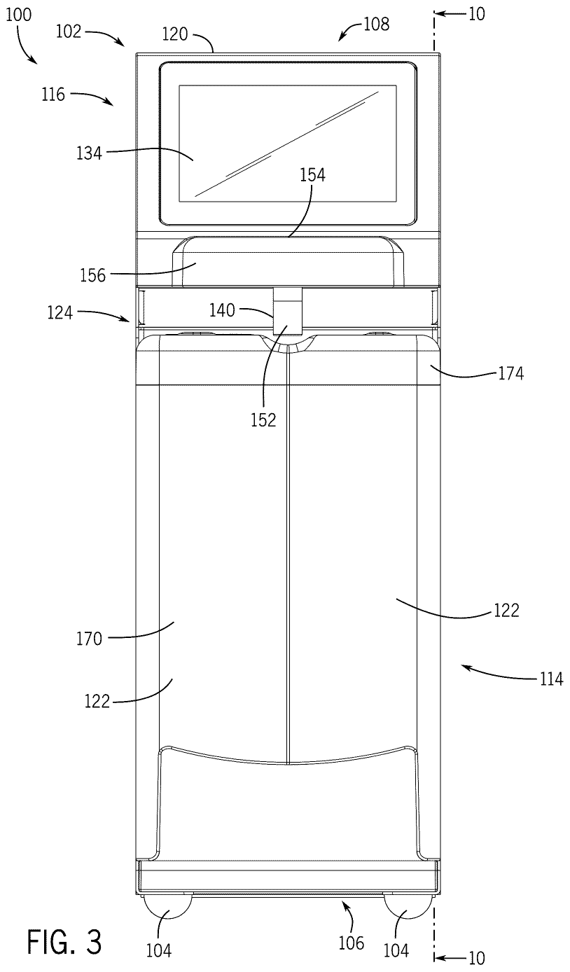

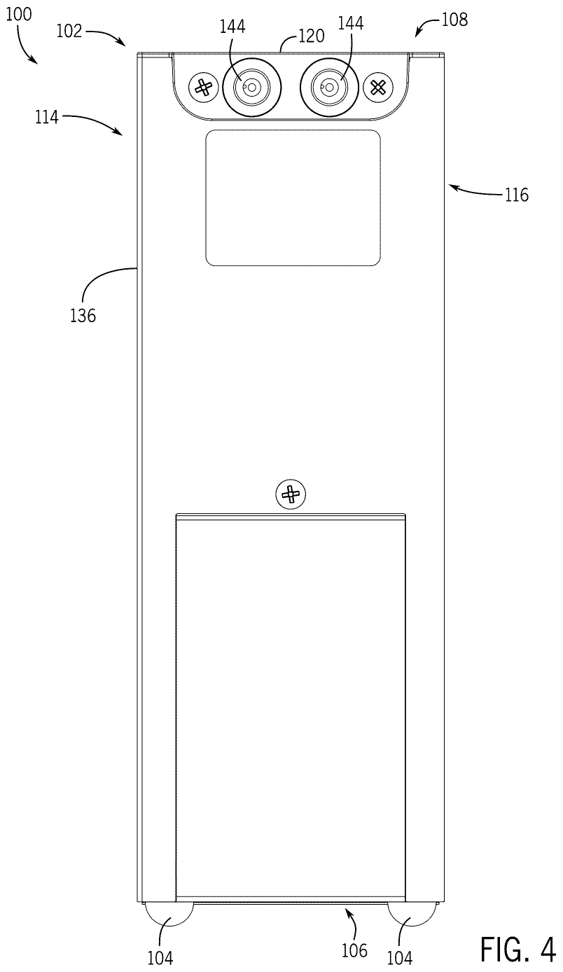

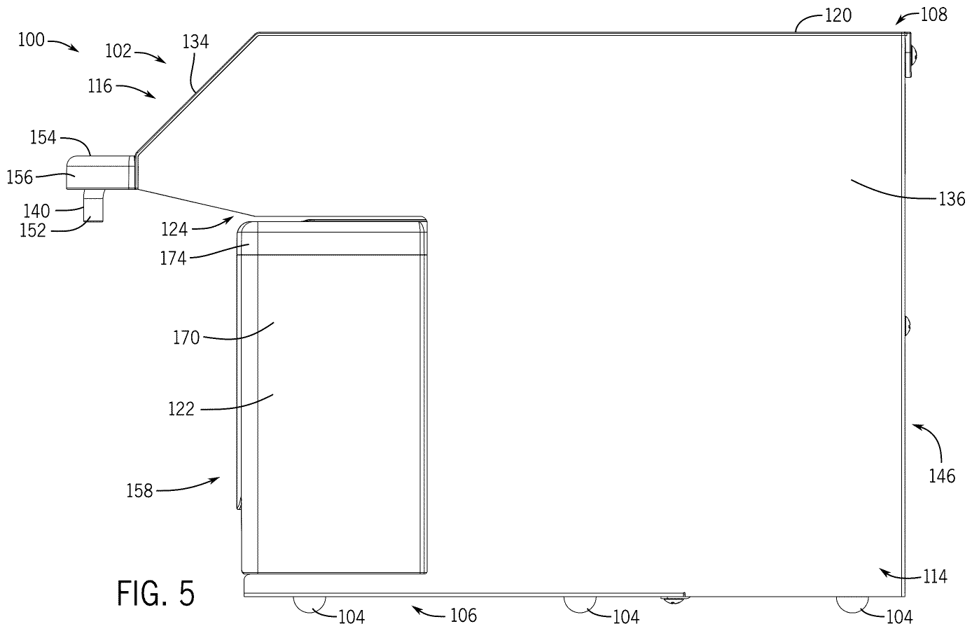

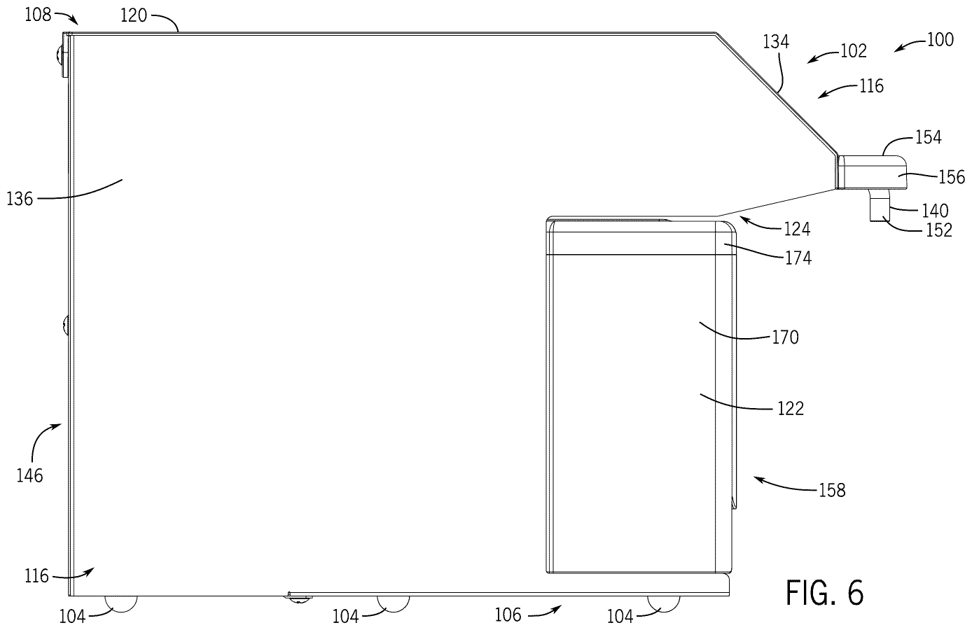

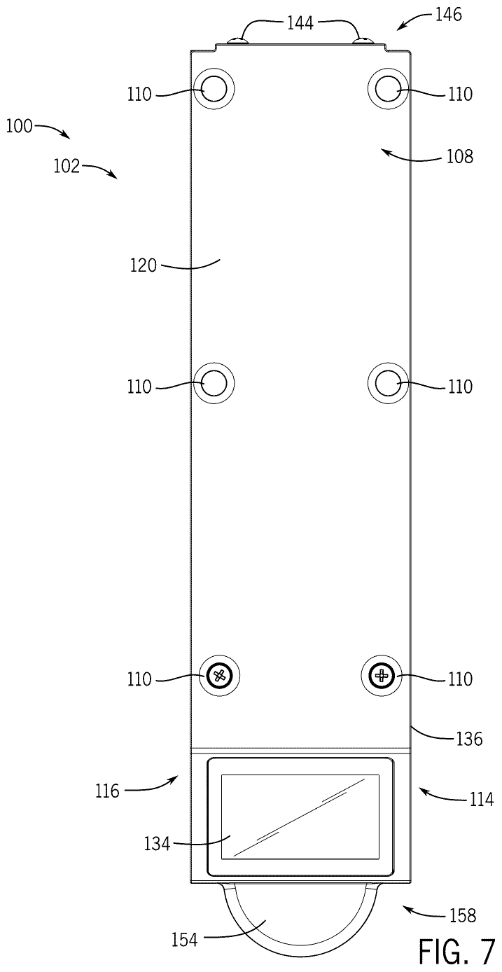

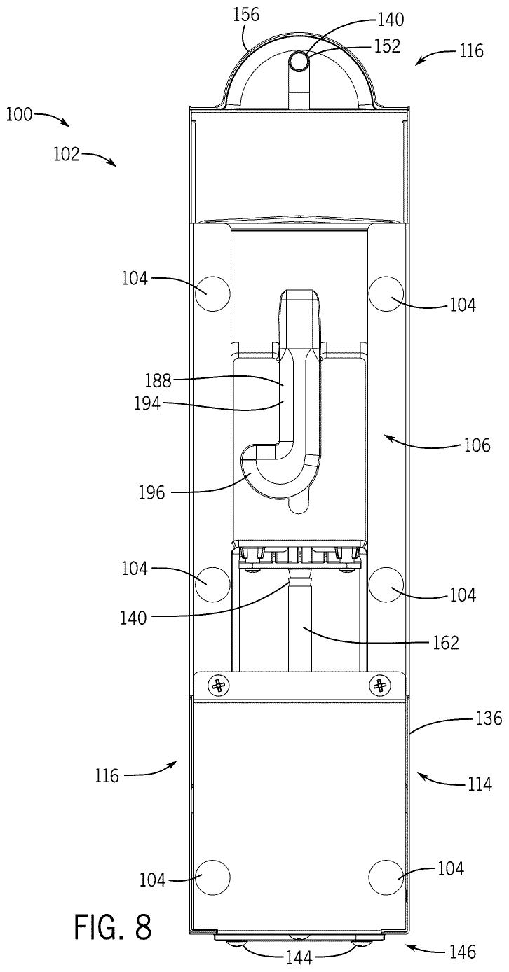

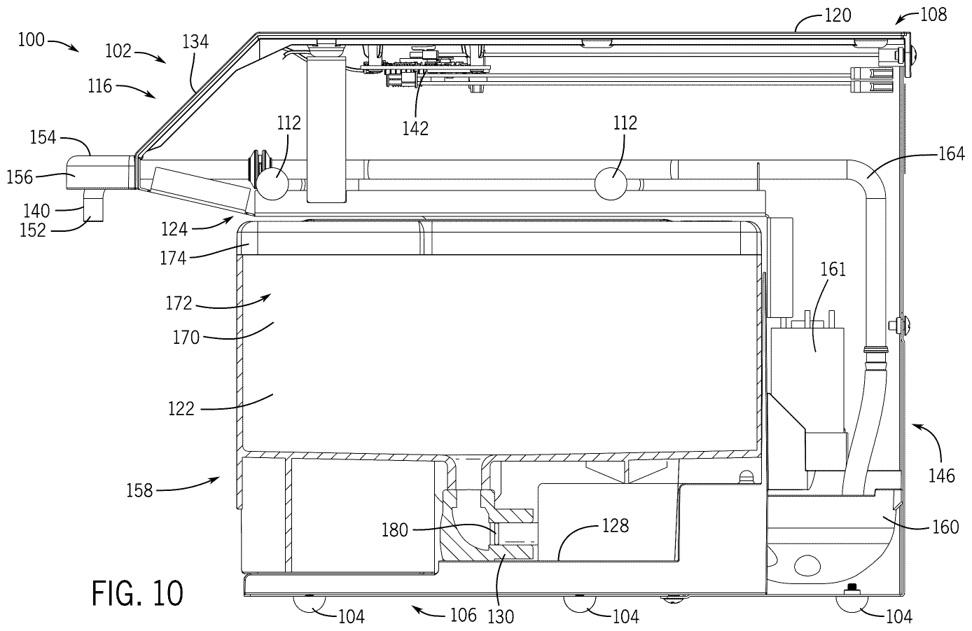

FIGS. 1-13 illustrate a non-limiting example of a dispensing system 100 configured to dispense a flowable food product, according to aspects of the disclosure. The dispensing system 100 can include one more dispensers 102, each of which can be configured to dispense a quantity or type of flowable food product. As illustrated, dispensers 102 can be arranged in a variety of ways relative to one another. In particular, dispensers 102 can be arranged in a linear or stacked configuration. Correspondingly, a dispenser 102 can be configured to couple with other dispensers 102 in the dispensing system 100. For example, a dispenser 102 can include feet 104 arranged along a bottom surface 106 of the dispenser 102, which can be configured to engage with a support surface (see e.g., FIG. 8). The support surface can be, for example, a table, counter, workstation, etc. A support surface can also be another dispenser when arranged in a stacked configuration. Accordingly, in some cases, a top surface 108 of the dispenser 102 can define pads 110 configured to engage with feet 104 of a corresponding dispenser stacked thereon. As shown in FIG. 2, the pads 110 can be formed as recesses configured to receive feet 104 of another dispenser 102 stacked thereon. Similarly, dispensers 102 can also be configured to couple with one another in a side-by-side configuration. For example, a dispenser 102 can include magnets 112 arranged on a side surface 114, 116 of the dispenser 102 (see e.g., FIG. 10), which can magnetically couple with an immediately adjacent dispenser. In other non-limiting examples, dispensers can be coupled in other ways (e.g., via fasteners, brackets, latches, etc.) to secure both stacked and side-by-side configurations of dispensers. In yet other non-limiting examples, and depending on the particular application, dispensers can be arranged separately from one another, or in various groups. The particular arrangement of the dispensing system 100 can be selected in accordance with desired layout or workflow of a kitchen. Thus, while FIG. 1 shows a two-by-two arrangement of dispensers 102 (e.g., stacked two dispensers high and two across), other arrangements with more or fewer dispensers 102 are possible. For example, sixteen food product dispensers can be organized in a side-by-side relationship such that all of the same sixteen sauces are available for use and application to a food item, or as a four-by-four arrangement with dispensers stacked four high and four across.

As mentioned above, a dispensing system can include one or more dispensers to dispense a type or quantity of flowable food product. In some cases, a single dispenser can be configured to dispense a desired quantity (e.g., by volume or by weight) of one or more types of a flowable food product (e.g., via one or more nozzles). The flowable food product can be retained in a reservoir that can couple to a base unit configured to dispense the flowable food product from the reservoir. Accordingly, the base unit can be configured to control dispensing of the food product in accordance with an input from a user or kitchen management system.

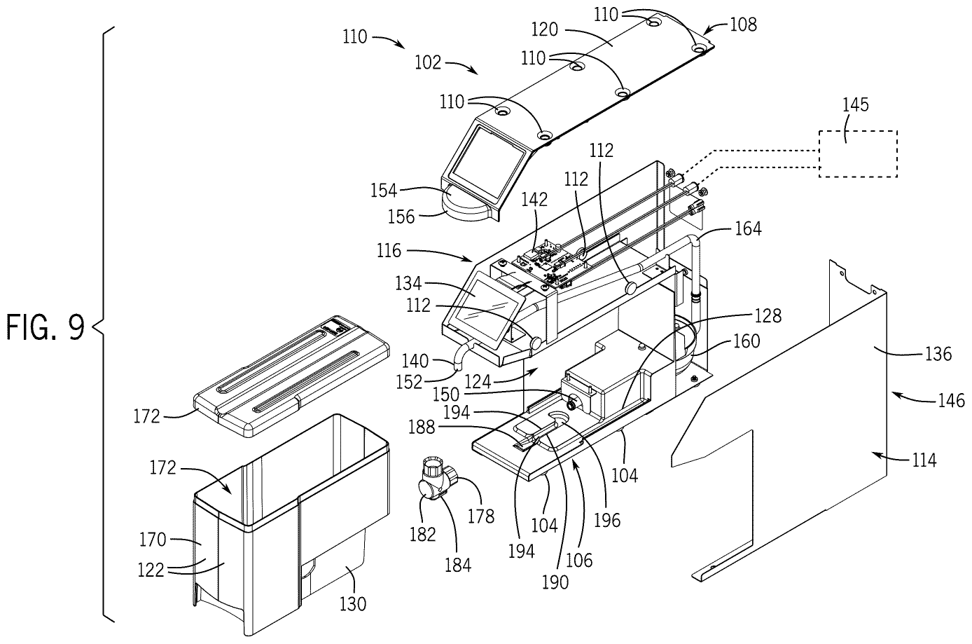

For example, referring to FIGS. 2-10, a dispensing system 100 can include a dispenser 102 having a base unit 120 (e.g., a dispensing unit) that is configured to couple to a reservoir 122 to dispense a flowable food product therein. More specifically, the reservoir 122 can be inserted into an opening 124 (e.g., a receiving area) of the base unit 120 to dispense flowable food product, and removed from the opening 124 to allow for refilling of the reservoir 122, as needed. The opening 124 can be shaped to receive at least a portion of the reservoir 122. In some cases, the base unit 120 and the reservoir 122 can be correspondingly shaped to help guide the reservoir 122 as it is inserted into the opening, ensuring that the reservoir 122 couples to the base unit 120. For example, as shown in FIG. 9, the opening 124 can define channels 128 that are configured to receive corresponding legs 130 of the reservoir 122. In this way, the legs 130 of the reservoir 122 can slide within the channels 128 and control lateral movement of the reservoir 122 while inserting the reservoir 122 into the opening 124. In other non-limiting examples, a reservoir can be coupled to a base unit differently.

When a reservoir (e.g., reservoir 122) is coupled to a base unit (e.g., base unit 120), the base unit can control dispensing of the flowable food product based on an input signal. The input signal can be provided as a manual input signal from a worker (e.g., via a user interface), or as an electronic signal provided by an external kitchen management system (e.g., for automatic dispensing based on a customer order). In some cases, the input signal may include information as to the type or quantity of flowable food product. In some case, the input signal may include information on the customer order and the base unit can be configured to determine and automatically dispense a corresponding type or quantity of flowable food product based on the order. For example, the base unit can dispense a flowable food product based on a type or quantity of a food item in an order.

A base unit a can further include a user interface that can be configured to receive a user input or to display a status of the dispenser to a user. In the illustrated non-limiting example, the base unit 120 includes a user interface 134 configured as a touch screen that can allow a user to provide an input signal via virtual buttons displayed thereon. In other non-limiting examples, physical input controls (e.g., dials, buttons, switches, etc.) can be provided. The user interface 134 may also display a status of the dispenser 102 to a user. For example, the user interface 134 can display the type of flowable food product being or available to be dispensed, a quantity being dispensed, a fill level of the reservoir, etc. In other non-limiting examples, the other types of status indicators may be provided, including, for example, visual indicators (e.g., lights), auditory indicators, etc. Furthermore, while each dispenser 102 of the dispensing system 100 may be provided with its own user interface, as shown in the illustrated non-limiting example, a dispensing system may include a single user interface configured to control multiple dispensers.

The user interface 134 can be configured to allow the user to control an amount of dispensed food product based on a variety of input options, and in some cases, may be customizable by a user. For example, a user interface can be configured for any use, portion size, dispensing amount or in any other way desired. It is contemplated that other different configurations for the user interface of the control panel could be utilized while operating within the scope of the present disclosure, such as but not limited to specific control buttons or any other type of interface. In some non-limiting examples, a user interface could include multiple selection areas that allow the operator to select between the type of food product upon which the dispensed sauce will be placed. As an example, the selection areas could include “boneless”, “bone-in” and “cauliflower”. It is contemplated that these selection buttons could identify a wide variety of different types of food products depending upon the desired use of the food product dispenser of the present disclosure. In some non-limiting examples, a user interface could include multiple size engagement areas for each of the product selection areas. The volume dispensing areas can allow the user to control the amount of sauce that will be dispensed onto the food product. In some non-limiting examples, the size engagement areas could include “Small”, “Medium”, and “Large”, etc., Thus, if the user selects a boneless wing option, the user can then select a small, medium or large order of boneless wings. The same holds true for the selection of bone-in or cauliflower. The user interface could further includes a refill indicator and a reset area if desired.

In another contemplated embodiment of the user interface of the control panel, the control panel could include five different size engagement areas instead of small, medium and large. The size areas allow the user to select the number of individual food items in a food product order. As an example, if the user selects Traditional wings, the user can then select between 6, 10, 15, 20 and 30 wings within an order. The number of wings within an order will dictate the amount of sauce that is dispensed onto the food item.

In another contemplated embodiment, the control panel can include a touch area labels as “manual” or “free pour”. Such area would allow a user to manually dispense the flowable food product from the food product dispenser. As an example, one press of the manual button area will prime the pump while holding the manual button will allow for a free pour until the desired amount of sauce has been dispensed.

To dispense the flowable food product, a base unit can include a controller that is configured to receive the input signal and to control a pump system to pump flowable product through the base unit from a reservoir. In some cases, the controller can be configured to determine the amount of flowable food product to be dispensed based on the input signal. For example, a controller can include an encoder to monitor operation of the pump to accurately control an amount of flowable food product that is dispensed. Correspondingly, when and input signal is received by the controller, the controller can make a determination of the amount of time or the number of rotations the pump system needs to operate to dispense the desired amount of sauce onto the food product. For an example, a boneless wing may require less sauce than a bone-in or traditional wing. Thus, if the user or kitchen management system commands a boneless wing order and that ten wings are within this order, the controller can determine the amount of sauce that needs to be dispensed. The amount of sauce dispensed for a boneless wing order of ten pieces may be less than the amount of sauce needed to be dispensed onto traditional wings of a similar ten piece order. As an illustrative example, one unit of sauce may be required for a boneless wing while 1.5 units of sauce may be required for a traditional wings.

Once the controller determines the amount of sauce that needs to be dispensed based upon the type of food item and the size of the order of food item, the controller can initiate the operation of a drive motor for a pump. The combination of the drive motor and pump are operable to dispense an accurately known volume of flowable food product for each rotation of the drive shaft. For example, by counting the numbers of rotations of a drive shaft of a pump, the controller and motor can accurately meter and control the amount of flowable food product being dispensed from the food product dispenser. In this manner, the controller can accurately control the amount and volume of flowable food product dispensed. In this manner, the restaurant or food service facility can accurately and repeatedly dispense the desired amount of sauce or other flowable food product onto a food item. This allows for consistency across multiple restaurant locations and can reduce waste.

With particular reference to FIGS. 8 and 9, the dispenser 102 includes a housing 136. The housing 136 can be formed of a durable, cleanable material, such as metals, polymers, etc., and may include one or more removal panels (e.g., side, top, bottom, back, front, etc.) that can be removed to allow for cleaning or maintenance of any internal components. For example, the housing 136 houses a pump system 140 and a controller 142 (e.g., an electronic controller) that is configured to operate the pump system 140 to dispense a flowable food product (e.g., to pump a desired amount of flowable food product from the reservoir 122). The controller 142 can receive power via terminals 144. The terminals 144 can be configured to allow multiple dispensers to be daisy-chained together to allow power distribution between the various dispensers of the dispensing system 100. In other cases, terminals 144 can receive power from a mains power source (e.g., an outlet), or a power distribution unit (PDU, i.e., a power supply) 145, which can be configured to supply electrical power to one or more dispensers of the dispensing system 100. The PDU 145 can be configured to convert the utility power source to the required voltage and current to operate the pump system 140. In addition, the PDU 145 can provide the required voltage and current to power the controller 142. In some cases, the terminals 144 may also allow communication between the various dispensers or an external device (e.g., a kitchen management system). Here, the terminals 144 are disposed along a rear surface 146 of the dispenser 102; however, terminals may be positioned differently in other examples. Additionally, the controller 142 is in communication with the user interface 134 to allow communication therebetween.

Based on the input signal, the controller 142 can operate the pump system 140 to control dispensing of the flowable food product from the reservoir 122. The pump system 140 is disposed within a housing 136 of the base unit 120 and includes a base unit connector 150 (e.g., a first connector that defines an inlet of the base unit 120), which is configured to couple with and receive the flowable food product from the reservoir 122, as well as a nozzle 152 (e.g., an outlet of the base unit 120) configured to dispense the flowable food product from the dispenser 102. The base unit connector 150 can extend into the opening 124 of the base unit 120 to allow the base unit connector 150 to couple with the reservoir 122 when it is inserted into the opening 124. The nozzle 152 can be disposed on a front side 158 of the base unit 120 and can formed from a metal (e.g., stainless steel, aluminum, etc.) or polymeric material that is durable and can be easily cleaned. More specifically, the nozzle 152 may define a frontmost part of the pump system 140. In some cases, the nozzle 152 may be partially covered by a shroud 154 of the housing 136, but may otherwise define a frontmost part of the dispenser 102 (e.g., to be forward of the reservoir 122). An area below the nozzle 152 (e.g., relative to a vertical direction taken between the bottom surface 106 and the top surface 108) may be an open space to allow a receptable (e.g., a mixing bowl, serving dish, etc.) to be placed directly underneath the nozzle 152 for dispensing. The distance that the nozzle 152 extends downward and away from the front of the housing 136 can be adjusted depending on the type of food product that is being presented beneath the nozzle 152, or the type of flowable food product being dispensed. Correspondingly, the shroud 154 may be configured to protect the nozzle 152 from contamination (e.g., drips from a stacked dispenser), as well as to indicate a location of the nozzle 152 to a user. For example, in the illustrated non-limiting example, the shroud 154 has an arcuate front surface 156 and the nozzle 152 is positioned proximate the apex of the actuate front surface 156.

To move the flowable food product from the base unit connector 150 to the nozzle 152, pump system 140 can further include a pump 160 (e.g., a peristaltic, flexible impeller, modular, or other type pump) configured to transport flowable food product from the reservoir 122 to the nozzle 152. The particular type of pump selected based on the type of flowable food product being dispensed. In this case, the pump 160 is secured to a back wall of the housing 136 that is configured to engage with the reservoir 122. However, the pump 160 may also be arranged differently within the housing 136 based on the particular application. In this way, the pump 160 can be separated from the reservoir 122 to reduce or eliminate direct contact with the flowable food product during operation of the dispensing system 100, while still allowing the pump interface (e.g., the base unit connector 150) to be cleaned in place when the reservoir 122 is removed.

The controller 142 can supply power to the pump 160 (e.g., a motor 161 of the pump 160) to cause flow through the pump system 140. In some cases, the motor 161 can be operatively coupled to the pump 160 via a direct connection to a drive shaft of the motor 161, or via a transmission (e.g., a geartrain, drive belt, etc.) Correspondingly, the pump system 140 may further include conduit (e.g., flexible or rigid tubing, pipe, or hose) to allow flowable food product to flow through the dispenser. With particular reference to FIG. 10, the pump system 140 can include a first conduit 162 that extends from the base unit connector 150 to the pump 160 and a second conduit 164 that extends from the pump 160 to the nozzle 152. In some cases, the pump 160 can be a food-grade pump that can be configured to allow for clean-in-place applications. In this way the pump system 140 can be operated to clean the dispenser 102 without requiring that a user take the dispenser 102 apart for cleaning.

As mentioned above, a reservoir can be configured to hold a flowable food product and to couple with a pump system of a base unit for dispensing. With continued reference to FIGS. 9 and 10, the reservoir 122 can be configured to hold and temporarily store flowable food product. In general, the reservoir 122 can include body 170 defining an interior cavity 172 that is configured to hold the flowable food product. In some cases, the body 170 can be configured to directly hold the flowable food product (e.g., in a direct-pour application from a can or jug), or to hold a container for the flowable food product (e.g., a flexible bag, etc.). In some cases, the body 170 can be sized to hold standard or custom sizes of containers for the flowable food product (e.g., 64 oz., 128 oz, etc. containers), such that an entire container can be emptied into the reservoir 122 during a refill. Where the reservoir 122 is configured to hold a container of the flowable food product, the reservoir 122 may be configured to couple to a nozzle or other opening of the container. Further, the reservoir 122 can include a cover 174 that is removable from the body 170 to prevent contamination while still allowing for periodic refilling of the reservoir 122. In some cases, the reservoir 122 (e.g., the body 170) can define a handle 171 (see FIG. 2) to allow a user to grasp the reservoir 122.

To allow the reservoir 122 to couple with the pump system 140, the reservoir 122 can include a reservoir connector 178 (e.g., a second connector that forms an outlet of the reservoir 122) that is configured to couple with the base unit connector 150. Here, the reservoir connector 178 is provided along a bottom of the reservoir 122, which can allow gravity to cause a flowable food product therein to flow toward the reservoir connector 178 during operation. Correspondingly, the interior cavity 172 of the reservoir 122 can be shaped (e.g., angled, tapered, etc.) to direct flow of the flowable food product toward the reservoir connector 178, which can help ensure that flowable food product is evacuated from the reservoir 122 by the pump system 140. That is, a sloped floor of the reservoir 122 can cause the flowable flood product to flow under the influence of gravity toward the reservoir connector 178 to be discharged from the reservoir 122. In other examples, a reservoir connector can be positioned differently.

In some cases, a reservoir connector and a base unit connector can be configured to form a fluid tight seal with one another to prevent leakage therethrough. For example, still referring to FIGS. 9 and 10, the reservoir connector 178 and the base unit connector 150 can be configured as push fit connectors so that the reservoir connector 178 and base unit 120 couple as the reservoir 122 is inserted into the opening 124 and decouple as the reservoir 122 is removed from the opening 124. In this case, the base unit connector 150 is configured as a male-type connector and the reservoir connector 178 is configured as a female-type connector that is configured to receive the base unit connector 150. At least one of the base unit connector 150 and the reservoir connector 178 can include a seal (e.g., an O-ring or other type of sealing element). Here, the base unit connector 150 includes a seal 180 that is positioned on an outer surface of the base unit connector 150 to engage an inner surface of the reservoir connector 178, forming a seal therebetween. In other applications, connectors can be configured differently.

To further prevent leakage when inserting and removing a reservoir from a base unit, at least one of the reservoir and the base unit can include a valve that is configured to open as the reservoir connects with the base unit and to close as the reservoir disconnects with the base unit. More specifically, the valve can be configured to engage with the base unit or reservoir as the reservoir is inserted or removed. The relative movement between the reservoir and the base unit can actuate the valve (e.g., to move an actuation lever) thereby opening and closing a respective one of the reservoir connector and the base unit connector. Actuation of the valve may occur while the reservoir is sealingly coupled to the base unit (e.g., via the respective connectors) to further reduce leaks. Moreover, actuation of the valve can be caused in a variety of ways. For example, a valve can be mechanically actuated via engagement of the valve with either the reservoir or base unit, or electronically actuated via a switch or sensor that is activated based on the insertion and removal of the reservoir from the base unit (e.g., the presence of the reservoir in the opening of the base unit). In some cases, multiple valves can be included, for example, with a first valve provided on the reservoir and a second valve provided on the base unit (e.g., on pump thereof).

In the illustrated non-limiting example, the reservoir 122 includes a valve 182 configured to open and close the reservoir connector 178. The valve 182 is operable between a closed positioned that blocks flow out of the reservoir connector 178 and an open position that allows flow out of the reservoir connector 178. Here, the valve 182 is configured as a ball valve with a lever 184 that can be moved (e.g., rotated or otherwise actuated) to open and close the valve 182; however, other types of valves may also be used. The lever 184 and the base unit 120 are respectively configured so that movement of the reservoir 122 relative to the base unit 120 opens and closes the valve 182. For example, in the illustrated non-limiting example, the base unit 120 defines a slot 188 that is configured to receive the lever 184. In this case, the slot 188 if formed along a bottom of the base unit 120, within the opening 124; however, slots can be arranged different in other non-limiting examples. The slot 188 is shaped so that, as the reservoir 122 is inserted into the opening 124 of the base unit 120, the lever 184 is rotated in a first rotational direction (e.g., anti-clockwise) to move the valve 182 from a closed configuration to an open configuration, and as the reservoir 122 is removed from the opening 124 of the base unit 120, the lever 184 is rotated in a second rotational direction (e.g., clockwise) to move the valve 182 from the open configuration to the closed configuration. Rotation of the lever 184 in the each of the first rotational direction and the second rotational direction is caused by the lever 184 engaging with the sides of the slot 188.

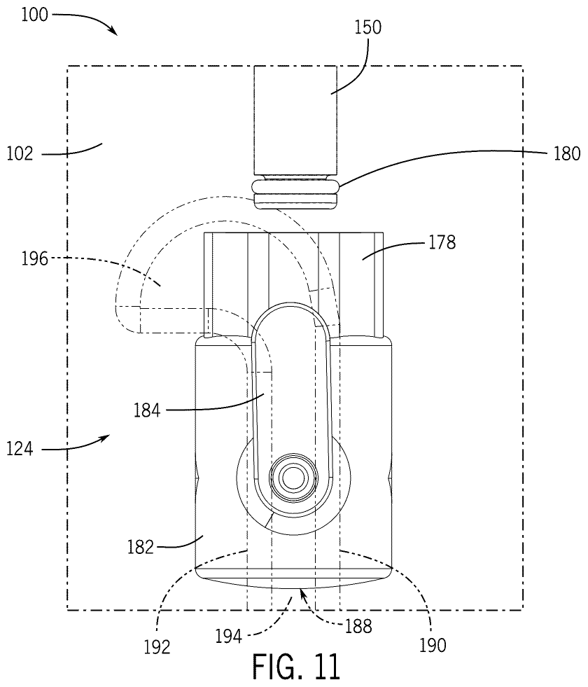

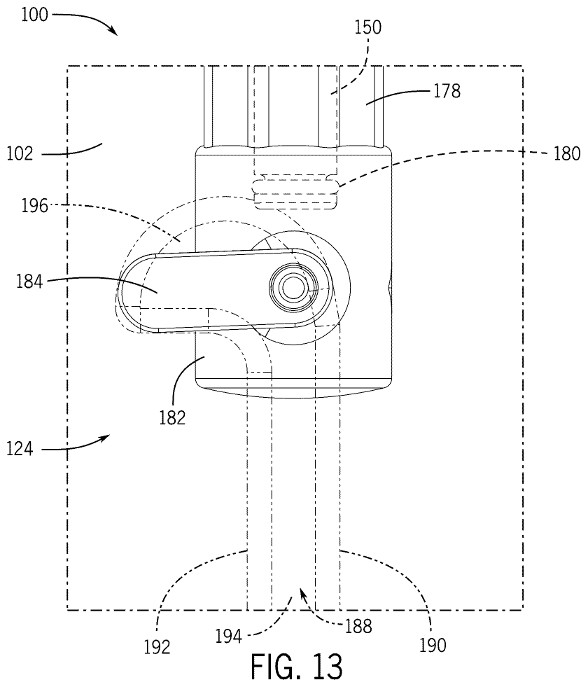

For example, with additional reference to FIGS. 11-13, the slot 188 is defined by a first side 190 and a second side 192 that are arranged to form a J-shape having a substantially straight region 194 (e.g., a first region) and a curved region 196 (e.g., a second region). The straight region 194 can correspond with a fully closed configuration of the valve 182. That is, the straight region 194 can be configured to place the lever 184 in a first lever position (e.g., a rotational position) to close the valve 182. More specifically, when in the straight region 194 (see e.g., FIG. 11), the lever 184 engages with the sides of the slot 188 to be in the first lever position that corresponds to the closed configuration of the valve 182. Accordingly, the curved region 196 can correspond with a fully open configuration of the valve 182 (e.g., to a maximum open position permitted by the slot 188, or a maximum open position of the valve 182). That is, the curved region 196 can configured to place the lever 184 in a second lever position to open the valve 182. More specifically, when in the curved region 196 (see e.g., FIG. 13), the lever 184 engages with the sides of the slot 188 to be in the second lever position that corresponds to the open configuration of the valve 182.

Inserting and removing the reservoir 122 from the opening 124 can cause the lever 184 to move along the slot 188 between the straight region 194 and the curved region 196 to move (e.g., rotate) the lever 184 between the first and second lever positions, which in turn, opens and closes the valve 182. Accordingly, the curved region 196 can be located closer to the base unit connector 150 than the straight region 194 (e.g., to be further within the opening 124) so that the lever 184 moves from the first lever position to the second lever position when inserting the reservoir 122 into the opening, and from the second position to the first position when removing the reservoir 122 from the opening 124.

In some cases, a slot (e.g., a curved region thereof) can be positioned so that a valve opens and closes when a reservoir connector is sealingly engaged with a base unit connector. In this way a connection between the reservoir and base unit may remain closed unless a seal is formed therebetween to prevent leakage. For example, FIG. 11 shows the reservoir 122 in a first reservoir position (e.g., an insertion position), in which the base unit connector 150 is decoupled from the reservoir connector 178. In the first reservoir position, the lever 184 can positioned within (e.g., entirely within) the straight region 194 so that the first side 190 and second side 192 place the lever 184 into the first lever position to close the valve 182.

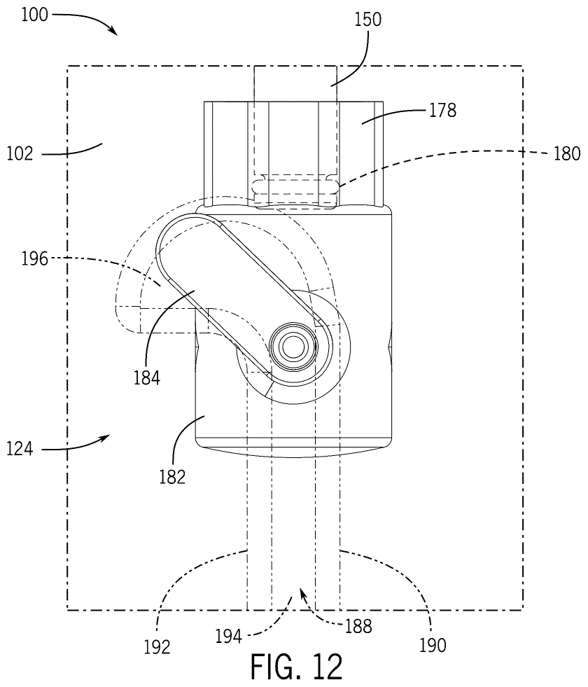

As the reservoir 122 is further inserted into the opening, the reservoir 122 can be in a second reservoir position shown in FIG. 12, in which the base unit connector 150 is partially received in the reservoir connector 178 and forms a seal therebetween. In the second reservoir position, the lever 184 (e.g., a distal end thereof) engages with the first side 190 within the curved region 196 and may disengage from the second side 192. The force exerted on the lever 184 by the first side 190, along with the curvature of the first side 190, causes the lever 184 to move from the first lever position toward the second lever position (e.g., to be at a third lever position between the first lever position and the second lever position), which can begin to open the valve 182. Put another way, in the second reservoir position, the lever 184 can be at a third lever position so that the valve 182 can remain closed but any further movement of the lever 184 toward the second lever position will cause opening of the valve 182 sufficient to allow a flowable food product to flow through the valve 182. Thus, the third lever position may correspond with a cracking position of the valve 182. In the second reservoir position, the lever 184 can be partially in both the straight region 194 and the curved region 196.

Continued insertion of the reservoir 122 into the opening 124 can place the reservoir 122 in a third reservoir position shown in FIG. 13. In the third reservoir position, the reservoir 122 can fully inserted into the base unit 120 and the base unit connector 150 can be fully received in the reservoir connector 178. Additionally, engagement of the lever 184 with the first side 190 of the slot 188 causes the lever 184 to reach the second lever position, fully opening the valve 182. In the third reservoir position, the lever 184 may engage with the second side 192 of the slot 188 and may be entirely within the curved region 196.

Similarly, removal of the reservoir 122 from the base unit 120 can cause the valve 182 to reattain the closed configuration. That is, as the reservoir 122 is removed from the opening 124, engagement of the lever 184 with the second side 192 of the slot 188 can move the lever 184 from the second lever position to the first lever position. In particular, when the reservoir 122 moves from the third reservoir position (see FIG. 13) to the second reservoir position (see FIG. 12), the lever 184 can engage with the second side 192 of the slot 188 and disengage with the first side 190 of the slot 188. The force exerted on the lever 184 by the second side 192, along with the curvature of the second side 192, causes the lever 184 to move from the first lever position toward the second lever position, which can begin to close the valve 182. The valve 182 becomes closed upon reaching the second reservoir position, while the base unit connector 150 remains partially received by the reservoir connector 178 to maintain the seal therebetween. Continued removal of the reservoir 122 from the second reservoir position to the first reservoir position causes the lever 184 to reach the first lever position and for the base unit connector 150 to fully disconnect from the reservoir connector 178, breaking the seal therebetween. Thus, a valve may only be opened while a reservoir is sealingly coupled with the base unit to prevent leakage. Moreover, insertion and removal of the reservoir can automatically cause the valve to be opened and closed

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A dispensing system for a flowable food product, the dispensing system comprising:
a base unit configured to dispense the flowable food product and defining an opening that includes a base unit connector; and
a reservoir configured to be inserted into the opening and to hold the flowable food product to be dispensed by the base unit, the reservoir including a reservoir connector configured to couple to the base unit connector and a valve configured to open and close to control a flow of flowable food product from the reservoir, wherein inserting the reservoir into the opening causes the valve to open and removing the reservoir from the opening causes the valve to close.

2. The dispensing system of claim 1, wherein the valve is configured to open when the reservoir connector is coupled with the base unit connector.

3. The dispensing system of claim 1, wherein the valve includes a lever that is configured to engage with the base unit, the lever configured to move between a first lever position that closes the valve and a second lever position that opens the valve.

4. The dispensing system of claim 3, wherein the base unit includes a slot formed within the opening, the slot configured to receive the lever and to move the lever between the first lever position and the second lever position.

5. The dispensing system of claim 4, wherein the slot has a J-shape with a straight portion configured to place the lever in the first lever position and a curved region configured to place the lever in the second lever position.

6. The dispensing system of claim 5, wherein the curved region is positioned closer to the base unit connector than is the straight region so that inserting the reservoir into the opening moves the lever from the first lever position to the second lever position and removing the reservoir from the opening moves the lever from the second lever position to the first lever position.

7. The dispensing system of claim 4, wherein inserting the reservoir into the opening causes the lever to engage with a first side of the slot to rotate the lever from the first lever position to the second lever position and removing the reservoir from the opening causes the lever to engage with a second side of the slot to rotate the lever from the second lever position to the first lever position.

8. The dispensing system of claim 1, wherein the reservoir is configured to move relative to the base unit between each of:
a first reservoir position in which the reservoir connector is decoupled from the base unit connector and the valve is closed;
a second reservoir position in which the reservoir connector is coupled to the base unit connector and the valve is closed; and
a third reservoir position in which the reservoir connector is coupled to the base unit connector and the valve is open.

9. The dispensing system of claim 1, wherein the base unit further includes a pump system retained within a housing of the base unit and an electronic controller configured to operate the pump system to dispense the flowable food product from the reservoir.

10. The dispensing system of claim 9, wherein the electronic controller is configured to dispense the flowable food product based on an input signal provided by at least one of a user interface and a kitchen management system.

11. The dispensing system of claim 1, wherein the dispenser and the reservoir collectively form one of a plurality dispensers that are arranged in at least one of a stacked configuration and a side-by-side configuration.

12. A method of using a dispensing system, the method comprising:
inserting a reservoir into an opening defined in a base unit to couple the reservoir to a pump system of the base unit and to cause a valve to move from a closed configuration to an open configuration to allow a flowable food product to flow from the reservoir to the pump system; and
removing the reservoir from the opening to decouple the reservoir from the pump system and to cause the valve to move from the open configuration to the closed configuration to block the flow of the flowable food product from the reservoir to the pump system.

13. The method of claim 12, wherein the valve is coupled to the reservoir and includes a lever that is configured to move with a slot defined by the base unit.

14. The method of claim 13, wherein inserting the reservoir into an opening moves the lever from a first region of the slot to a second region of the slot to open the valve and removing the reservoir from the opening moves the lever from the second region to the first region to close the valve.

15. The method of claim 14, wherein the second region is positioned so that the reservoir is coupled to the pump system when the valve transitions between the open configuration and the closed configuration.

16. A dispenser for a dispensing system, the dispenser comprising:
a dispensing unit defining an opening; and
a reservoir configured to sealingly couple to the dispensing unit and including a valve configured to control a flow of a flowable food product from the reservoir to the dispensing unit, the reservoir being moveable within the opening between each of a first reservoir position in which the reservoir is decoupled from the dispensing unit and the valve is closed, a second reservoir position in which the reservoir is coupled to the base unit connector and the valve is closed, and a third reservoir position in which the reservoir is coupled to the base unit connector and the valve is open.

17. The dispenser of claim 16, wherein dispensing unit includes a slot that is configured to receive and rotate a lever to open and close the valve.

18. The dispenser of claim 17, wherein the slot defines a first region corresponding to a fully closed configuration of the valve and a second region corresponding to a fully open configuration of the valve.

19. The dispenser of claim 18, wherein the lever is in the first region when the reservoir is in the first reservoir position, the lever is in the second region when the reservoir is in the third reservoir position, and the lever is in both the first region and the second region when the reservoir is in the second reservoir position.

20. The dispenser of claim 16, wherein the lever is in a first rotational position when the reservoir is in the first reservoir position, a second rotational position when the reservoir is in the third reservoir position, and a third lever position when the reservoir is in the second reservoir position, the third rotational position corresponding to a cracking position of the valve.
